(19) United States
(12) Patent Application Publication
(10) Pub. No.: US 2005/0010588 A1
(43) Pub. Date: Jan. 13, 2005

(54) Method and apparatus for determining replication schema against logical data disruptions

(76) Inventors: Stephen H. Zalewski, Pleasant Hill, CA (US); Aida McArthur, Sunnyvale, CA (US)

Correspondence Address: KENYON & KENYON, Suite 600, 333 W. San Carlos, Street, San Jose, CA, 95110-2711, US

(21) Appl. No.: 10/616,131

(22) Filed: Jul. 8, 2003

(51) Int. Cl. G06F 17/00

(52) U.S. Cl. 707/102; 707/100

(57) ABSTRACT

A method and apparatus for managing the protection of stored data from logical disruptions are disclosed. The method may include storing a set of data on a data storage medium, displaying a graphical user interface to a user, wherein the graphical user interface is a graphical representation of a replication schema to protect the set of data against logical disruption, and providing the user with an ability to modify the replications schema through the graphical user interface.

### CROSS REFERENCE TO RELATED APPLICATIONS

This application is related by common inventorship and subject matter to co-filed and co-pending applications titled “Methods and Apparatus for Building a Complete Data Protection Scheme”, “Method and Apparatus for Protecting Data Against any Category of Disruptions” and “Method and Apparatus for Creating a Storage Pool by Dynamically Mapping Replication Schema to Provisioned Storage Volumes”, filed June _{—}, 2003. Each of the aforementioned applications is incorporated herein by reference in its entirety.

### TECHNICAL FIELD OF THE INVENTION

The present invention pertains to a method and apparatus for preserving computer data. More particularly, the present invention pertains to replicating computer data to protect the data from physical and logical disruptions of the data storage medium.

### BACKGROUND INFORMATION

Many methods of backing up a set of data to protect against disruptions exist. As is known in the art, the traditional backup strategy has three different phases. First the application data needs to be synchronized, or put into a consistent and quiescent state. Synchronization only needs to occur when backing up data from a live application. The second phase is to take the physical backup of the data. This is a full or incremental copy of all of the data backed up onto disk or tape. The third phase is to resynchronize the data that was backed up. This method eventually results in file system access being given back to the users.

However, the data being stored needs to be protected against both physical and logical disruptions. A physical disruption occurs when a data storage medium, such as a disk, physically fails. Examples include when disk crashes occur and other events in which data stored on the data storage medium becomes physically inaccessible. A logical disruption occurs when the data on a data storage medium becomes corrupted or deleted, through computer viruses or human error, for example. As a result, the data storage medium is still physically accessible, but some of the data contains errors or has been deleted.

Protections against disruptions may require the consumption of a great deal of disk storage space.

### SUMMARY OF THE INVENTION

A method and apparatus for managing the protection of stored data from logical disruptions are disclosed. The method includes storing a set of data on a data storage medium, displaying a graphical user interface to a user, wherein the graphical user interface is a graphical representation of a replication schema to protect the set of data against logical disruption, and providing the user with an ability to modify the replications schema through the graphical user interface.

### BRIEF DESCRIPTION OF THE DRAWINGS

The invention is described in detail with reference to the following drawings wherein like numerals reference like elements, and wherein:

FIG. 1 illustrates a diagram of a possible data protection process according to an embodiment of the present invention.

FIG. 2 illustrates a block diagram of a possible data protection system according to an embodiment of the present invention.

FIG. 3 illustrates a possible snapshot process according to an embodiment of the present invention.

FIG. 4 illustrates a flowchart of a possible process for performing back-up protection of data using the logical replication process according to an embodiment of the present invention.

FIG. 5 illustrates a flowchart of a possible process for providing a graphical user interface (GUI) according to an embodiment of the present invention.

FIG. 6 illustrates a possible GUI capable of administering a data protection schema to protect against logical disruptions according to an embodiment of the present invention.

### DETAILED DESCRIPTION OF THE PREFERRED EMBODIMENTS

A method and apparatus for managing the protection of stored data from logical disruptions are disclosed. A source set of stored data may be protected from logical disruptions by a replication schema. The replication schema may create static replicas of the source set of data at various points in the data set's history. The replication process may create combinatorial types of replicas, such as point in time, offline, online, nearline and others. A graphical user interface may illustrate for a user when and what type of replication is occurring. The schematic blocks of the graphical user interface may represent the cyclic nature of protection strategy by providing an organic view of retention policy, replication frequency, and storage consumption. A block may represent each replication, with the type of block indicating the type of point-in-time (hereinafter, “PIT”) copy being created. Each group of blocks may represent the time interval over which that set of replications is to occur. Each block may be color-coded to indicate which copy is acting as the source of that set of data.

In order to recover data, an information technology (hereinafter, “IT”) department must not only protect data from hardware failure, but also from human errors and such. Overall, the disruptions can be classified into two broad categories: “physical” disruptions, that can be solved by mirrors to address hardware failures; and “logical” disruptions that can be solved by a snapshot or a PIT copy for instances such as application errors, user errors, and viruses. This classification focuses on the particular type of disruptions in relation to the particular type of replication technologies to be used. The classification also acknowledges the fundamental difference between the dynamic and static nature of mirrors and PIT copies. Although physical and logical disruptions have to be managed differently, the invention described herein manages both disruption types as part of a single solution.

Strategies for resolving the effects of physical disruptions call for following established industry practices, such as setting up several layers of mirrors and the use of failover system technologies. Mirroring is the process of copying data continuously in real time to create a physical copy of the volume. Mirrors contribute as a main tool for physical replication planning, but it is ineffective for resolving logical disruptions.

Strategies for handling logical disruptions include using snapshot techniques to generate periodic PIT replications to assist in rolling back to previous stable states. Snapshot technologies provide logical PIT copies of volumes of files. Snapshot-capable volume controllers or file systems configure a new volume but point to the same location as the original. No data is moved and the copy is created within seconds. The PIT copy of the data can then be used as the source of a backup to tape, or maintained as is as a disk backup. Since snapshots do not handle physical disruptions, both snapshots and mirrors play a synergistic role in replication planning.

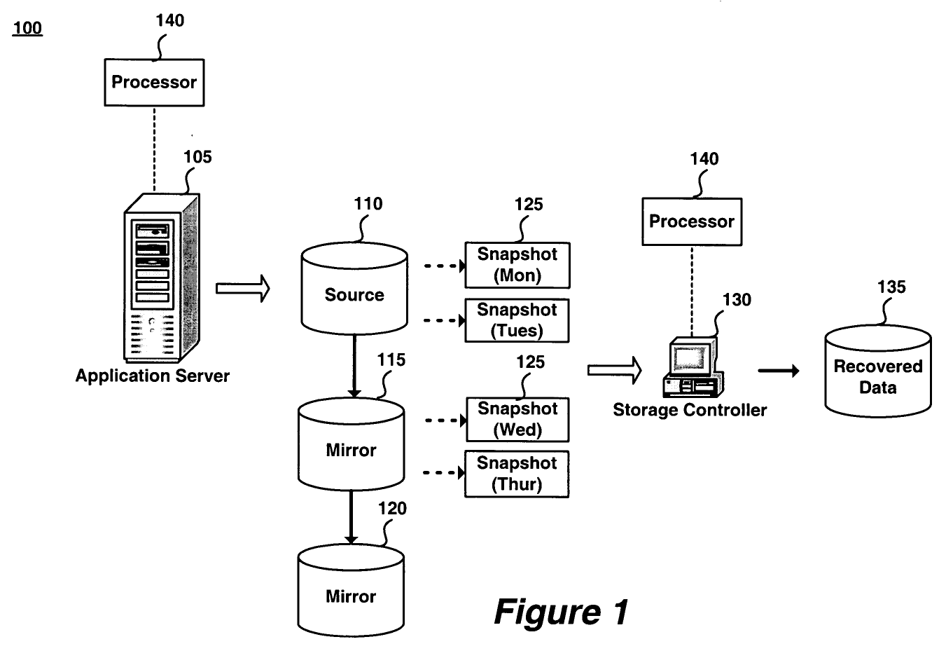

FIG. 1 illustrates a diagram of one possible embodiment of the data protection process 100. An application server 105 may store a set of source data 110. The server 105 may create a set of mirror data 115 that matches the set of source data 110. Mirroring is the process of copying data continuously in real time to create a physical copy of the volume. Mirroring often does not end unless specifically stopped. A second set of mirror data 120 may also be created from the first set of mirror data 115. Snapshots 125 of the set of mirror data 115 and the source data 110 may be taken to record the state of the data at various points in time. Snapshot technologies may provide logical PIT copies of the volumes or files containing the set of source data 110. Snapshot-capable volume controllers or file systems configure a new volume but point to the same location as the original source data 110. A storage controller 130, running a recovery application, may then recover any missing data 135. A processor 140 may be a component of, for example, a storage controller 130, an application server 105, a local storage pool, other devices, or it may be a standalone unit.

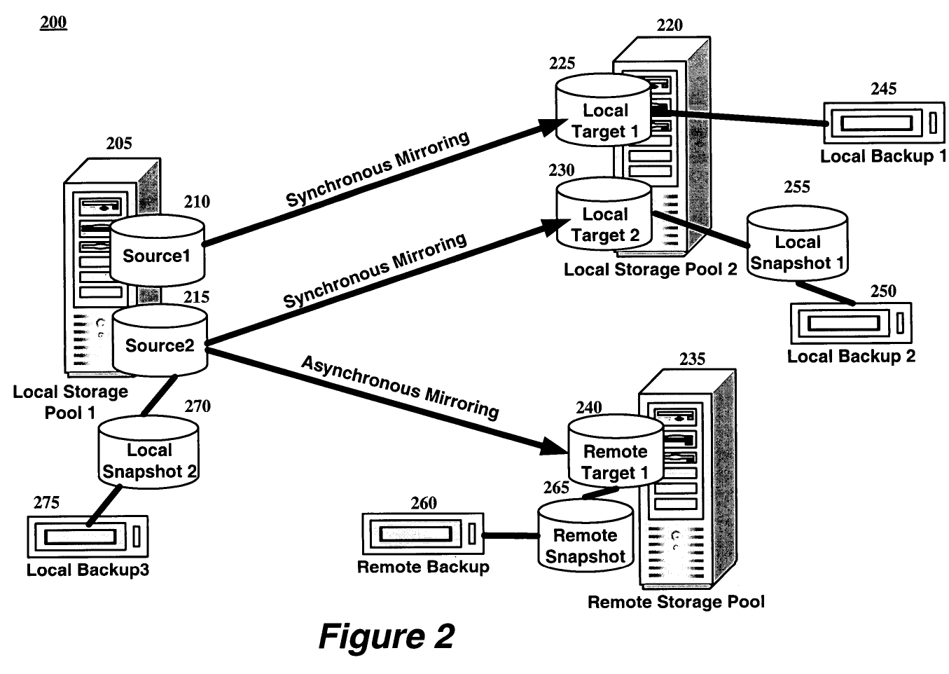

FIG. 2 illustrates one possible embodiment of the data protection system 200 as practiced in the current invention. A single computer program may operate a backup process that protects the data against both logical and physical disruptions. A first local storage pool 205 may contain a first set of source data 210 to be protected. One or more additional sets of source data 215 may also be stored within the first local storage pool 205. The first set of source data 210 may be mirrored on a second local storage pool 220, creating a first set of local target data 225. The additional sets of source data 215 may also be mirrored on the second local storage pool 220, creating additional sets of local target data 230. The data may be copied to the second local storage pool 220 by synchronous mirroring. Synchronous mirroring updates the source set and the target set in a single operation. Control may be passed back to the application when both sets are updated. The result may be multiple disks that are exact replicas, or mirrors. By mirroring the data to this second local storage pool 220, the data is protected from any physical damage to the first local storage pool 205.

One of the sets of source data 215 on the first local storage pool 205 may be mirrored to a remote storage pool 235, producing a remote target set of data 240. The data may be copied to the remote storage pool 235 by asynchronous mirroring. Asynchronous mirroring updates the source set and the target set serially. Control may be passed back to the application when the source is updated. Asynchronous mirrors may be deployed over large distances, commonly via TCP/IP. Because the updates are done serially, the mirror copy 240 is usually not a real-time copy. The remote storage pool 235 protects the data from physical damage to the first local storage pool 205 and the surrounding facility.

In one embodiment, logical disruptions may be protected by on-site replication, allowing for more frequent backups and easier access. For logical disruptions, a first set of target data 225 may be copied to a first replica set of data 245. Any additional sets of data 230 may also be copied to additional replica sets of data 250. An offline replica set of data 250 may also be created using the local logical snapshot copy 255. A replica 260 and snapshot index 265 may also be created on the remote storage pool 235. A second snapshot copy 270 and a backup 275 of that copy may be replicated from the source data 215.

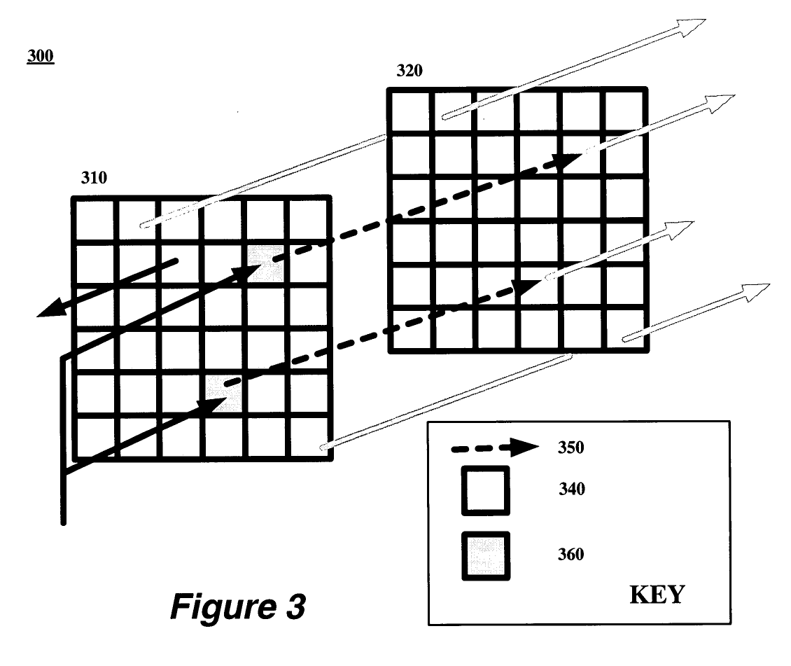

FIG. 3 illustrates one possible embodiment of the snapshot process 300 using the copy-on write technique. A pointer 310 may indicate the location on a storage medium of a set of data. When a copy of data is requested using the copy-on-write technique, the storage subsystem may simply set up a second pointer 320, or snapshot index, and represent it as a new copy. A physical copy of the original data may be created in the snapshot index when the data in the base volume is initially updated. When an application 330 alters the data, some of the pointers 340 to the old set of data may not be changed 350 to point to the new data, leaving some pointers 360 to represent the data as it stood at the time of the snapshot 320.

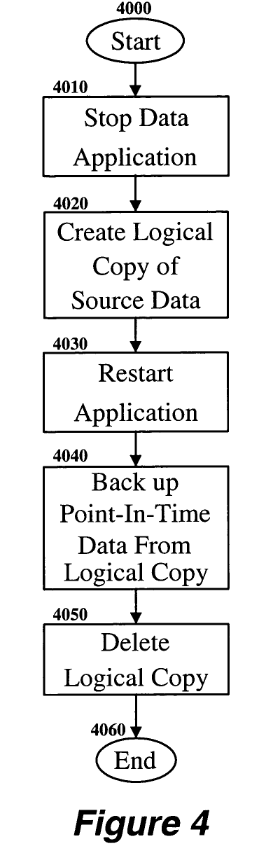

FIG. 4 illustrates in a flowchart one possible embodiment of a process for performing backup protection of data using the PIT process. At step 4000, the process begins and at step 4010, the processor 140 or a set of processors stops the data application. This data application may include a database, a word processor, a web site server, or any other application that produces, stores, or alters data. If the backup protection is being performed online, the backup and the original may be synchronized at this time. In step 4020, the processor 140 performs a static replication of the source data creating a logical copy, as described above. In step 4030, the processor 140 restarts the data application. For online backup protection, the backup and the original may be unsynchronized at this time. In step 4040, the processor 140 replicates a full PIT copy of the data from the logical copy. The full PIT copy may be stored in a hard disk drive, a removable disk drive, a tape, an EEPROM, or other memory storage devices. In step 4050, the processor 140 deletes the logical copy. The process then goes to step 4060 and ends.

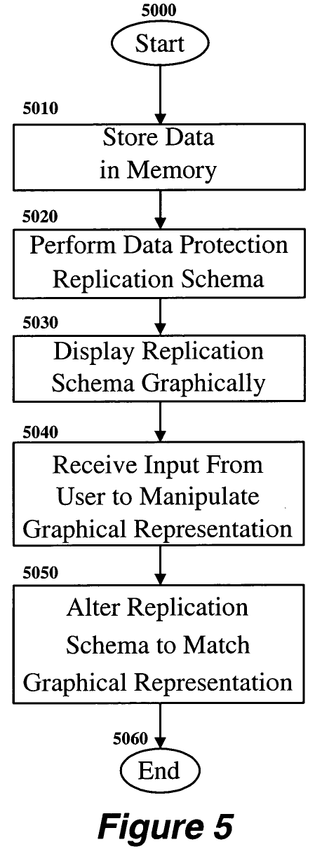

FIG. 5 illustrates in a flowchart one possible embodiment of a process for providing a graphical user interface (GUI) to allow a user to build and organize a data protection schema to protect against logical disruptions. At step 5000, the process begins and at step 5010, the processor 140 or a set of processors stores a source set of data in a data storage medium, or memory. This memory may include a hard disk drive, a removable disk drive, a tape, an EEPROM, or other memory storage devices. In step 5020, the processor 140 performs a data protection replication schema as described above. The data may be copied within the memory by doing a direct copy, by broken mirroring, by creating a snapshot index to create a PIT copy, or by using other copying methods known in the art. In step 5030, on a display, such as a computer monitor or other display mechanisms, the processor 140 shows a graphical user interface to the user representing the replication schema graphically. In step 5040, the processor 140 receives changes to be made to the graphical representation from a user via an input device. The input device may be a touch pad, mouse, keyboard, light pen, or other input devices. In step 5050, the processor 140 alters the replication schema to match the changes made by the user to the graphical representation. The process then goes to step 5060 and ends.

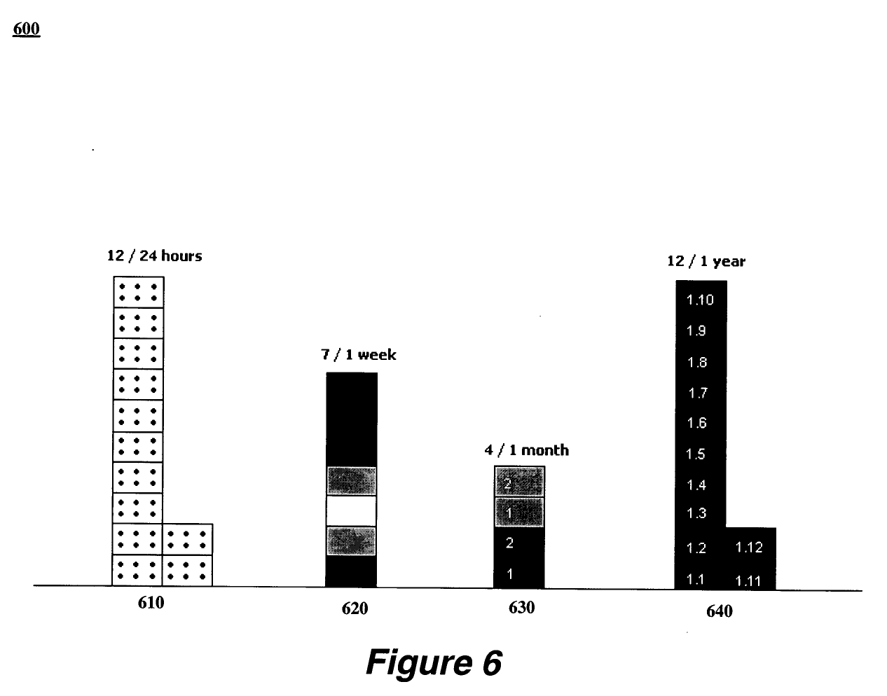

FIG. 6 illustrates one embodiment of a GUI 600 capable of administering a data protection schema to protect against logical disruptions. In this GUI, a block may represent each replication of the source set of data. The source set of data may represent multiple volumes of data stored in a variety of memory storage mediums. The first group of blocks 610 may represent the number of replications of the source set of data that occur within a day. Each block in the first group 610 may represent a snapshot partial copy of the source set of data rather than a complete copy. After the proper number of copies is created, the oldest copy may be overwritten, keeping the total number of copies to a number fixed by the user. The second group of blocks 620 may represent the number of replications of the source set of data that occur within a week. Each block in the second group 620 may represent a complete copy of the source set of data, as opposed to a snapshot partial copy. Each block may be color-coded to differentiate between the blocks of this sub-group. The third group of blocks 630 and the fourth group of blocks 640 may represent a month or year of replications, respectively. The third group of blocks 630 and the fourth group of blocks 640 may be color-coded to indicate which of the second group of blocks 620 served as a source of the copy. A user could change the color to designate a different source block.

The number of blocks in a given time period may be changed, causing more or less replications to occur over a given time period. The type of blocks may also be changed to indicate the type of replication to be performed, be it a full copy or only a snapshot of the set of data. The blocks can also be altered to indicate an online or an offline copy. Drop-down menus, cursor activated fields, lookup boxes, and other interfaces known in the art may be added to allow the user to control performance of the protection process. Instead basing it on a set number of replications per month, the limits on replication may be memory based. Other constraints may be placed on the replication schema as required by the user.

As shown in FIGS. 1 and 2, the method of this invention may be implemented using a programmed processor. However, method can also be implemented on a general-purpose or a special purpose computer, a programmed microprocessor or microcontroller, peripheral integrated circuit elements, an application-specific integrated circuit (ASIC) or other integrated circuits, hardware/electronic logic circuits, such as a discrete element circuit, a programmable logic device, such as a PLD, PLA, FPGA, or PAL, or the like. In general, any device on which a finite state machine is capable of implementing the flowcharts shown in FIGS. 4 and 5 may be used to implement the data protection system functions of this invention.

While the invention has been described with reference to the above embodiments, it is to be understood that these embodiments are purely exemplary in nature. Thus, the invention is not restricted to the particular forms shown in the foregoing embodiments. Various modifications and alterations can be made thereto without departing from the spirit and scope of the invention.

1. A method, comprising:
storing a set of data on a data storage medium;
displaying a graphical user interface to a user, wherein the graphical user interface is a graphical representation of a replication schema to protect the set of data against logical disruption; and
providing the user with an ability to modify the replication schema through the graphical user interface.

2. The method of claim 1, further comprising modifying the replication schema based on input received from the user through the graphical user interface.

3. The method of claim 1, further comprising displaying a set of blocks on the graphical user interface, wherein each block represents an instance of replication.

4. The method of claim 3, wherein a subset of the set of blocks represents a snapshot copy.

5. The method of claim 3, wherein a subset of the set of blocks represents a full copy.

6. The method of claim 3, further comprising dividing the set of blocks into groups.

7. The method of claim 6, wherein each group represents a different time interval.

8. The method of claim 6, further comprising indicating whether a group is an online copy or an offline copy.

9. The method of claim 3, further comprising color-coding the set of blocks to indicate a point-in-time source set of data.

10. A set of instructions residing in a storage medium, said set of instructions capable of being executed by a storage controller to implement a method for processing data, the method comprising:
storing a set of data on a data storage medium; and
displaying a graphical user interface to a user, wherein the graphical user interface is a graphical representation of a replication schema to protect the set of data against logical disruption and provides the user with an ability to modify the replication schema.

11. The set of instructions of claim 10, further comprising modifying the replication schema based on input received from the user through the graphical user interface.

12. The set of instructions of claim 10, further comprising displaying a set of blocks on the graphical user interface, wherein each block represents an instance of replication.

13. The set of instructions of claim 12, wherein a subset of the set of blocks represents a snapshot copy.

14. The set of instructions of claim 12, wherein a subset of the set of blocks represents a full copy.

15. The set of instructions of claim 12, further comprising dividing the set of blocks into groups.

16. The set of instructions of claim 15, wherein each group represents a different replication interval.

17. The set of instructions of claim 15, further comprising indicating whether a group is an online copy or an offline copy.

18. The set of instructions of claim 12, further comprising color-coding the set of blocks to indicate a point-in-time source set of data

19. A processing system, comprising:
a memory that stores a set of data;
a processor that performs a replication schema to protect the set of data against logical disruptions;
a display that shows a graphical user interface representing a graphical representation of the replication schema; and
an input device that provides the user with the ability to modify the replication schema through the graphical user interface.

20. The processing system of claim 19, wherein a set of blocks is displayed on the graphical user interface with each block representing an instance of replication.

21. The processing system of claim 20, wherein a subset of the set of blocks represents a snapshot copy.

22. The processing system of claim 20, wherein a subset of the set of blocks represents a full copy.

23. The processing system of claim 20, wherein the set of blocks is divided into groups.

24. The processing system of claim 23, wherein each group represents a different replication interval.

25. The processing system of claim 20, wherein each block is color-coded to indicate a point-in-time source set of data.
